(19) United States
(12) Patent Application Publication
(10) Pub. No.: US 2008/0177557 A1
(43) Pub. Date: Jul. 24, 2008

(54) Promotional system

(76) Inventor: Iain Saul, Salt Lake City, UT (US)

Correspondence Address: THORPE NORTH & WESTERN, LLP., P.O. Box 1219, SANDY, UT, 84091-1219, US

(21) Appl. No.: 11/895,633

(22) Filed: Aug. 24, 2007

(51) Int. Cl. G09F 21/04; B29C 65/00; G06Q 90/00

(52) U.S. Cl. 705/1; 40/591; 156/60

(57) ABSTRACT

A method for promoting a matter in connection with a motor sports event comprises: soliciting from a plurality of participants at least one image associated with each of the participants; collecting a fee from each participant submitting, or endorsing, an image in response to the solicitation; assembling a mosaic from images provided by, or endorsed by, the participants; arranging the mosaic upon a vehicle that will compete in the motor sports event; attaching the mosaic to the vehicle; and facilitating provision of affirmation to the participants of the vehicle's participation in the motor sports event.

### PRIORITY CLAIM

Priority is claimed of copending U.S. Provisional Patent Application No. 60/840,372, filed Aug. 23, 2006, which is hereby incorporated herein in its entirety.

### BACKGROUND

1. Field of the Invention

The present invention relates generally to systems for enhancing promotional activities.

2. Related Art

Promotional methods are become increasingly important as organizations try to find interesting and innovative ways to promote various causes, events, celebrations and the like (hereinafter referred to collectively as “matters”). As consumers are continually exposed to promotional objects and methods, new and innovative manners of catching the attention of consumers are constantly being sought.

Many innovations have been developed for this purpose to promote matters at public events. For instance, some promotional methods are designed to raise funds or generate income at sporting related activities. Some of these innovations have involved participation from the public interested in viewing the public event. For example, some large sporting events have joined with soda pop producers to encourage people to view the sporting event (and buy more soda pop) by placing a random number on the tab of a soda container. At some point during the sporting event, a winning number is announced after which the viewers/consumers compare the number to the number on containers they posses and, if they are winners, redeem the tab to collect a prize. Unfortunately, most of these types of events have involved a random chance to win, regardless of the consumer's intent in purchasing the soda pop. Additionally, these types of promotional events have not provided a forum for willing participants to become a publicized and recognizable component of the promotional event.

### SUMMARY OF THE INVENTION

The invention provides a method for promoting a matter, including, in one embodiment: soliciting from a plurality of participants at least one image associated with each of the participants; assembling a mosaic from images provided by, or endorsed by, the participants; and attaching the mosaic to a three-dimensional object associated with the matter.

In accordance with another aspect of the invention, a method for promoting a matter in connection with a motor sports event is provided, including: soliciting from a plurality of participants at least one image associated with each of the participants; collecting a fee from each participant submitting, or endorsing, an image in response to the solicitation; assembling a mosaic from images provided by, or endorsed by, the participants; arranging the mosaic upon a vehicle that will compete in the motor sports event; attaching the mosaic to the vehicle; and facilitating provision of affirmation to the participants of the vehicle's participation in the motor sports event.

In accordance with another aspect of the invention, a method for promoting a matter in connection with a motor sports event is provided, including: soliciting from a plurality of participants at least one image representative of each of the participants; allowing each participant submitting, or endorsing, an image to select a vehicle upon which the participant's mosaic will be attached; collecting a fee from each participant submitting, or endorsing, an image in response to the solicitation; assembling a mosaic from collective images provided by, or endorsed by, the participants; arranging the mosaic upon a racecar that will compete in the motor sports event; attaching the mosaic to the vehicle; and facilitating provision of affirmation to the participants of the racecar's participation in the motor sports event.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a side view of a section of a promotional item in accordance with an embodiment of the present invention, with a mosaic formed thereon;

FIG. 2 is a side view of the promotional item of FIG. 1, with a mosaic formed thereon having a pre-defined border exhibiting a recognizable pattern when viewed from a distance;

FIG. 3 is an exemplary flowchart of a method for promoting a matter; and

FIG. 4 is an exemplary flowchart of a method for promoting a matter at a sporting event according to an embodiment of the present invention.

Reference will now be made to the exemplary embodiments illustrated, and specific language will be used herein to describe the same. It will nevertheless be understood that no limitation of the scope of the invention is thereby intended.

### DETAILED DESCRIPTION OF EXAMPLE EMBODIMENT(S)

Before the present invention is disclosed and described, it should be understood that this invention is not limited to the particular structures, process steps, or materials disclosed herein, but is extended to equivalents thereof as would be recognized by those of ordinarily skill in the relevant arts. It should also be understood that terminology employed herein is used for the purpose of describing particular embodiments only and is not intended to be limiting in any way.

### DEFINITIONS

In describing and claiming the present invention, the following terminology will be used in accordance with the definitions set forth below.

As used in this specification and the appended claims, the singular forms “a” and “the” include plural referents, unless the context clearly dictates otherwise. Thus, for example, reference to an “image” can, but does not necessarily, include one or more of such images.

As used herein, a “three-dimensional” object is understood to be an object that is non-planar in nature and that includes one or more surfaces that include differing planar features. Examples of three-dimensional objects include, without limitation, automobiles, athletic balls, etc. When a mosaic is applied to one or more surfaces of a three-dimensional object, the mosaic will include a non-planar display surface.

The discussion herein address systems to promote various “matters.” The term “matter,” as used herein, is to be understood to refer to an event, cause, organization, assemblage, etc. Nearly any type of object, event or organization that can benefit from promotional activities intended to raise public awareness of the object, event or organization can constitute a “matter,” as that term is utilized herein.

As used herein, the term “substantially” refers to the complete or nearly complete extent or degree of an action, characteristic, property, state, structure, item, or result. The exact allowable degree of deviation from absolute completeness may in some cases depend upon the specific context, however, generally speaking, the nearness of completion will be so as to have the same overall result as if absolute and total completion were obtained. The use of “substantially” is equally applicable when used in a negative connotation to refer to the complete or near complete lack of an action, characteristic, property, state, structure, item, or result.

### INVENTION

The present invention generally provides a system for promoting a matter (such as an event, organization, cause, product, etc.) in a manner in which participants (e.g., consumers, sports fans, charitable contributors, etc.) will find interesting and unique. In accordance with one embodiment of the invention, the method includes the steps of soliciting and obtaining a plurality of images, each being associated with a plurality of participants. The plurality of images can be assembled or organized to form a mosaic. The mosaic can then be attached to, fixed to or otherwise associated with a three-dimensional object. The three-dimensional object can then be used to promote the matter. Consumers or fans find the present invention unique and interesting, as the end product (the three-dimensional object) includes an image associated with the consumers, e.g., a photo or likeness of the consumer or fan, or some other image with which the fan has an emotional attachment, such as a photo of a loved one.

The system can be used to promote a variety of matters, including sporting events, and can be utilized to generate revenue for a charity by allowing fans of the sporting event to submit images to be associated with the object in exchange for a fee. In one embodiment, the three-dimensional object will be causally related to the event with which the promotion is associated. For example, the matter can be a motor sports event (e.g., NASCAR or a Formula One event), and the three-dimensional object can include a racecar participating the motor sports event.

This feature of the invention is advantageous in that a fan of the motor sports at issue may be particularly eager or willing to donate to a charity if he or she can witness his or her image displayed on the racecar in exchange for a donation.

As shown in FIG. 1, in one aspect of the invention, a promotional item or object for promoting a matter can include a racecar 20. A plurality of images (30a through 30f) can be assembled to collectively form a mosaic 26a. The mosaic 26a can be on side panel of the car, a hood panel or overlapping one or many exterior panels of the car. The racecar 20 can be used at a sporting event, such as a racing event, to promote the matter. The racing event may include other racecars designed as promotional items with each car promoting a separate matter; or with the combination of cars acting to promote the same matter. Alternatively, a racing event may have a plurality of race cars with only a few cars designed as promotional items. The racing event may be an exhibition designed to showcase the cars, or may include a sanctioned race, wherein the race involves racecars designed as promotional items.

The matter promoted by the racecar and sporting event may include a revenue generating event such as an event to raise money for charity, an advertising event for advertising an item or product, or a combination of both. For example, the racecar(s) and the racing event can be organized to generate money for a specific charity, or can be organized as part of an advertising campaign. In addition, the event may be organized as part of an advertising campaign and may used to generate money for a charitable organization.

In one example, the images associated with the racecar 20 can be provided by (or endorsed by, if the fan does not specifically chose the image) racing fans that have an interest in associating an image of their choice with the racecar. The provided images may include photographs, sketches, marks, written compositions, etc., of the fan submitting the image, or of someone selected by the fan. Thus, in one embodiment, the racecar can be associated with a plurality of racing fans photographs such that substantially the entire body of the car is decorated with photographs of fans. Other images may include photographs or sketches of places, homes, an animal or pet, etc.

In another aspect, the images may be provided by businesses having an interest in the promotional event or an interest in associating their business with the event. Likewise, the businesses may provide a variety of images such as photographs, sketches, marks, etc. For example, a business could provide a mark, such as a trademark or logo, or could provide an image of an item for advertising purposes. Furthermore, images provided by businesses could be used in combination with images provided by fans to decorate the racecar. The event may further include a race involving the cars thereby enhancing the interest level of the fans or businesses in associating their image(s) with a given car, in the hopes that the car they or it select wins the competition.

The racecar 20 of FIG. 1 includes a plurality of images 30a-30f that collectively form mosaic 26a. The mosaic 26a of FIG. 1 can include a border will ill-defined edges that covers a portion (or substantially all on a front end portion of the race car 20. The images 30a-30f may be assembled in an overlapping manner so that borders of adjacent images are contacting one another (or overlapping slightly) such that the mosaic has the appearance of a continuous structure of images. The ill-defined border of the mosaic can extend around the perimeter of the mosaic and can encompass the plurality of images. The portion of the three-dimensional object that is associated with the images can be defined by the size of the mosaic and the positioning of the mosaic in relation to the racecar. The mosaic can be designed so that substantially all of any exterior panels of the racecar are covered by a portion of the mosaic. The boundary of the mosaic may be designed to correspond with the boundary of the three-dimensional object. In such a configuration the three-dimensional object would appear to be completely decorated by images. For example, the boundary of a mosaic could incorporate the entire body of the racecar so that the entire racecar is decorated with images of photographs, sketches, marks, etc.

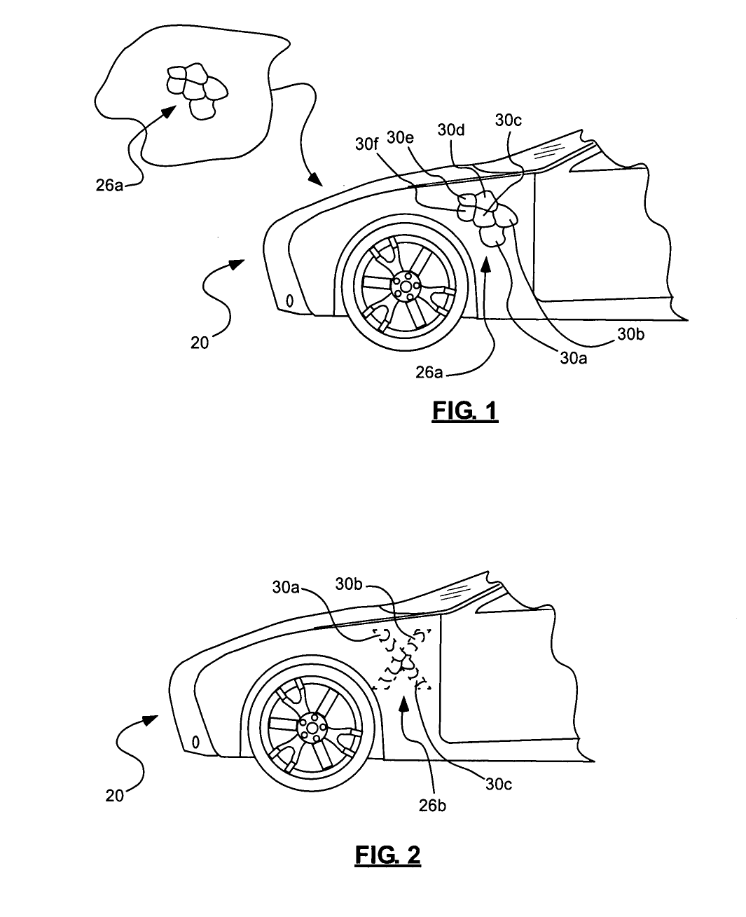

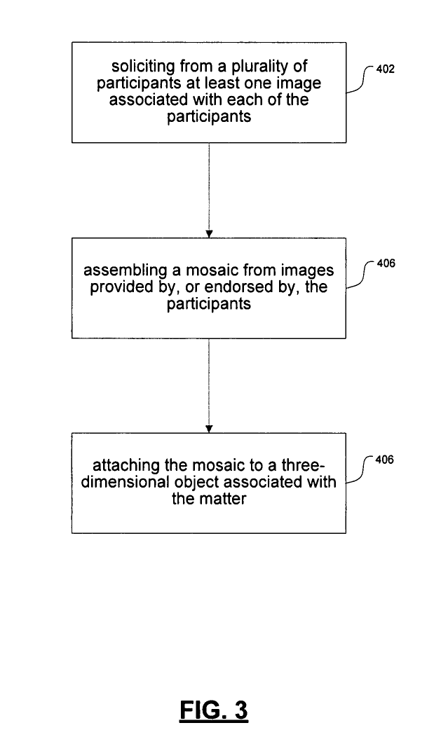

Referring now to FIG. 2, the mosaic 26b includes a plurality of images assembled in an ordered manner so that the combination of images forming the mosaic has a pre-designed configuration when viewed from afar. In one aspect, the mosaic may comprise a pre-designed configuration so that the assembled images form a mark or logo. Configuring the border of the mosaic permits a variety of shaped and sized image assemblies to be created. For example, the mosaic can be configured to form a variety of shapes or marks or a plurality of mosaics could be used to spell a word.

In another aspect, the images can be arranged in an ordered manner so that the combination of images produces a visual effect when viewed from afar while being individually visible when viewed at close range. For instance, the individual images can be arranged with reference to color and lighting so that the combination of images provides the mosaic with a distinct look. For example, darker images may be used toward the bottom of the mosaic and lighter images may be used toward the top of the mosaic, with images having varying degrees of brightness used intermediately to give the impression, when viewed from afar, that the mosaic seamlessly transitions from a darker bottom region to a lighter top region.

Additionally, the individual images can be arranged within the mosaic so that the images act to form a larger image when viewed from afar. For example, the images can be arranged with respect to color and brightness so that the combination of images forms a human face when the mosaic is viewed from afar while the individual images are visible when the mosaic is viewed at close range. Similarly, the arrangement of the images may be pre-designed so that a logo, mark, or word is formed within the mosaic. For example, the racecar could include a mosaic on its hood with the images arranged to form a logo or mark of a corporate sponsor while having a mosaic on its doors with the images arranged to form the car's number. Alternatively, the images may be arranged in a random manner so that the combination of images forming the mosaic has a random configuration when viewed from afar and so that the individual images are visible when viewed at close range.

The promotional item may also be designed so that the arrangement of images is determined by the parties providing the images. A party may be permitted to select the location of an image within the mosaic when the party provides the image. The selection of the image location may be contingent on a location's price or on a party's participation. With regard to a location's price, the image locations within the mosaic could correspond with a predetermined, “set” price, wherein more preferred locations have a higher price and less preferred locations have a lower price. Preferred locations could be determined based on the probability of a given location being viewed, where preferred locations have a greater probability of visibility and less preferred locations have a lower probability of visibility. A party providing an image may be more inclined to pay a higher price for a preferred location because of a greater probability of having his or her image more easily identifiable. With regard to a party's participation, the earliest participating parties could be permitted to have first selection at image location, thereby allowing first participants the opportunity to select preferred locations. Such an arrangement would provide a motivational incentive to parties to enlist early, since early participation would provide a greater opportunity to secure preferred locations.

The promotional event may further include a plurality of promotional items and may be arranged so that parties are permitted to choose a specific promotional item and location for displaying their image(s). The selection of promotional items and locations may be based on a location's/promotional item's price or on a party's participation as previously described. For instance, the racing event can include a plurality of racecars, wherein racing fans may select preferred cars and preferred locations based on the item's/location's price or based on the party's participation.

The promotional item may also be configured so that the three-dimensional object is associated with a plurality of mosaics that each include a different image arrangement pattern. For instance, the racecar can include a mosaic on the front portion that has a pre-designed boundary such as a logo or mark, a mosaic on the central portion that has an arrangement of images that form a face, and a mosaic on the rear portion that has a random orientation. Multiple arrangements of the images within the mosaic are possible and are considered within the scope of the invention.

The images can be associated with the three-dimensional object in a variety of manners. The images can be associated with the three-dimensional object by depositing the mosaic directly on the surface of the three-dimensional object or, alternatively, the mosaic may be deposited on a material and the material may be attached to the surface of the object. In one aspect, the plurality of images may be converted into an electronic file and assembled into the mosaic using a software program such as Mozaika™ or Mosaic Tools™. The electronic mosaic file may then be used to robotically paint spray the assembled images onto the surface of the car. In another aspect, the images may be assembled to form the mosaic and a template may be created from the mosaic to aid in the paint spraying process.

The mosaic may be shaped and sized in relation to the material such that the boundary of the mosaic corresponds with the boundary of a substrate material or such that the boundary of the mosaic is smaller than the boundary of the material, wherein the mosaic fits within the interior of the material. The mosaic can be formed on the surface of the material by assembling the images and depositing the assembly on the material's surface. In one aspect, the images may be deposited on the surface of the material by robotically paint spraying the images onto the material's surface as previously presented. In another aspect, the images may be deposited on the surface of the material by using a printing method such as dye sublimation.

The substrate material, having a mosaic of assembled images, may then be attached to the surface of the car by adhering the material to the car's surface. In one embodiment, a vinyl substrate is used as the material to receive assembled images and adhere to the car. However, a variety of materials could be used. In addition, a race car may be associated with a plurality of materials that each has a different mosaic or that have a portion of a single mosaic, wherein the combination of the plurality of materials form a single large mosaic.

In addition to the racecar promotional item discussed herein, the present system can be utilized with a variety of three-dimensional objects include, but not limited to, spherical objects such as basketballs or golf balls having a mosaic attached to the surface of the object. The mosaic 140 comprises a plurality of images 130 provided by fans of the sport associated with the object, wherein the images are assembled in the manner previously presented and contained within the interior of the mosaic's boundary 146. In these aspects, the boundary of the mosaic can be a designed to include only a portion of the ball, or the mosaic can be designed so that the boundary is defined by the boundary of the ball (e.g., the mosaic covers substantially all of the surface of the ball). The mosaic can also be formed directly on the surface of the ball, or can be formed on a material that is adhered to the ball as previously presented. The object in this embodiment can be used at a sporting event related to the object (e.g., a basketball game) to promote a matter as previously discussed.

The promotional item could also include a shirt or jersey to be worn by a professional athlete at a sporting event. The shirt or jersey could be associated with a plurality of assembled images provided by fans of the athlete or of the sport. Obviously, a variety of shaped and sized objects can be made to be associated with a mosaic of assembled images.

In another embodiment (not shown) the mosaic may be assembled from the plurality of images and converted into an electronic form such as an electronic image or file. The electronic image can then be displayed on an electronic device such as a screen or projector, thereby permitting the mosaic to be displayed electronically at a promotional event to promote a matter. For example, a promotional event at a baseball game could be organized to allow fans to submit images, such as photographs, to be assembled into an electronic mosaic that is to be broadcast on a projection screen at some time during the game. The images may be received from the fans in an electronic format, such as a photograph from a cellular phone, and arranged using a software program, such as the software programs referenced previously, to create an electronic mosaic image. Alternatively, hard copies of the images may be received and assembled and subsequently converted to an electronic form. In addition, the images may be assembled in an ordered manner as previously described to create a larger image within the mosaic. Likewise, the images may be assembled randomly or image location may be selected by the fans as previously set forth. It will be appreciated that a variety of promotional item may be created from various shaped and sized objects and can include mosaics having a variety of forms and is therefore, not meant to be limited in any way by the present embodiments.

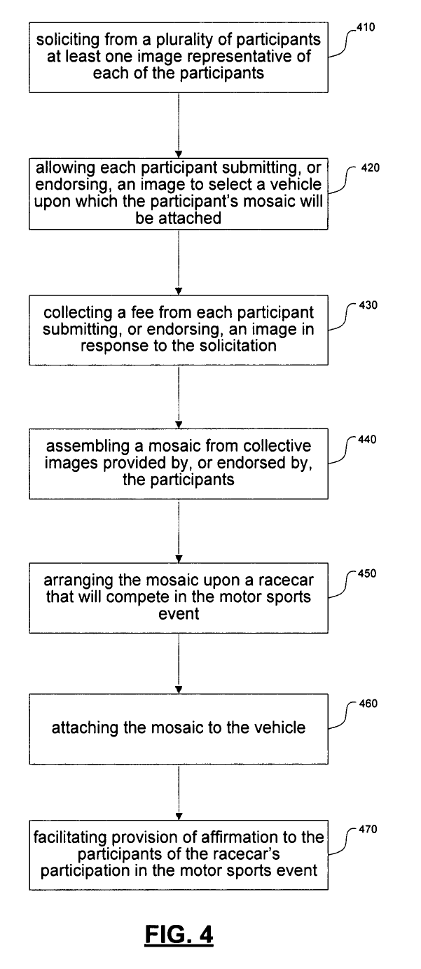

FIGS. 3 and 4 illustrate exemplary steps various embodiments of the invention. As shown in FIG. 3, in one aspect the invention can include the step of 402 soliciting from a plurality of participants at least one image associated with each of the participants. At 404 the method can include assembling a mosaic from images provided by, or endorsed by, the participants. At 406 the method can include the step of attaching the mosaic to a three-dimensional object associated with the matter.

In the embodiment illustrated in FIG. 4, the method can include the step of 410 soliciting from a plurality of participants at least one image representative of each of the participants. At 420 the method can include the step of allowing each participant submitting, or endorsing, an image to select a vehicle upon which the participant's mosaic will be attached. At 430, the method can include collecting a fee from each participant submitting, or endorsing, an image in response to the solicitation. At 440, the mosaic can be assembled from collective images provided by, or endorsed by, the participants. At 450, the mosaic can be arranged upon a racecar that will compete in the motor sports event. At 460 the mosaic can be attached to the vehicle. At 470 the method can include the step of facilitating provision of affirmation to the participants of the racecar's participation in the motor sports event.

The present system can be utilized to promote a matter, including generating interest or revenue for an event or cause. Similarly, promoting a matter may include a combination of advertising and revenue generating. For example, an organization can use the method to generate revenue for a charity or may use the method to advertise a new product. In addition, the method can be used at an event, such as a racing event as previously described, to generate greater interest in the promoted matter.

In one embodiment of the invention, the method is designed to promote the matter by involving parties that are interested in the matter or interested in the associated event. For example, the promotional method can be used to promote a matter at a racing event by displaying a racecar and associated images at the event. The fans of a racing event can be involved by providing the images to be associated with the racecar in exchange for a fee.

A website or other fan interface can be created as a manner to allow interested fans to submit images in exchange for a fee. The website can be configured to show fans the racecars that will be displayed/raced at the racing event, and the corresponding drivers that will drive the racecars. The website may be further configured to permit fans to select a racecar and corresponding driver to associate the fan's image(s). Additionally, the website can be designed to show the fan a representation of how the mosaic will be positioned on the racecar's surface and to show the possible locations on the surface of the racecar where the images may be positioned along with corresponding locations within the mosaic.

In one aspect, the website can provide the fan with a three-dimensional representation of the racecar, wherein the representation may be rotated and zoomed by the fan to show all the image locations on the car's surface and within the mosaic. The three-dimensional representation of the racecar would provide the fan with a perception of how the image would appear in relation to the car and in relation to the other images. The website may then be designed to permit a fan to select a location for placement of the image within the mosaic by allowing the fan to select a desired image location on the surface of the car and placing the image in a corresponding location within the mosaic. The website would thus allow a racing fan to select a racecar, according to the type of car or driver, and allow the racing fan to select a location on the surface of the racecar for placement of a provided image. As described previously, fees can be arranged to correspond with image locations so that preferred locations have a higher price then less preferred locations.

Once a racecar and image location is selected and an appropriate fee has been paid, the website may then be designed to facilitate receiving the image by permitting a fan to upload the image to the website. The site may then be made to assemble the received images according to the fans placement or according to some pre-designed configuration to facilitate deposition of the mosaic on the racecar's surface such as in a manner previously set forth.

After the completion of the racing event, the fan can be sent a replica model of the racecar decorated with the same mosaic thereon as the original racecar. The fan can also receive a framed and signed plot map detailing exactly where his or her image was positioned within the mosaic on the particular racecar used in the racing event.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

I claim:

1. A method for promoting a matter, comprising:
soliciting from a plurality of participants at least one image associated with each of the participants;
assembling a mosaic from images provided by, or endorsed by, the participants; and
attaching the mosaic to a three-dimensional object associated with the matter.

2. The method of claim 1, wherein at least some of the images provided by, or endorsed by, the participants are representations of people.

3. The method of claim 2, wherein at least some of the representations of people are representations of the participants solicited.

4. The method of claim 1, wherein at least some of the images provided by, or endorsed by, the participants are logos or marks associated with business entities.

5. The method of claim 1, wherein the matter includes a charitable organization or event.

6. The method of claim 1, wherein the three-dimensional object is a racecar.

7. The method of claim 6, wherein the participants solicited are racing enthusiasts.

8. The method of claim 1, wherein the images provided by, or endorsed by, the participants are assembled into the mosaic in a random pattern, such that borders of the mosaic define a random pattern.

9. The method of claim 1, wherein the images provided by, or endorsed by, the participants are assembled into the mosaic in an ordered manner, such that borders of the mosaic define a recognizable pattern.

10. The method of claim 1, further comprising:
establishing a minimum number of images desired to form the mosaic;
soliciting participants to submit at least one image to be included in the mosaic in exchange for a fee; and
collecting images from participants until the minimum number of images is obtained from the participants.

11. The method of claim 10, wherein at least some of the participants solicited can select a location upon the three-dimensional object in which the images submitted by the participants will be located.

12. The method of claim 1, wherein the mosaic is fixed to the surface of the three-dimensional object.

13. A method for promoting a matter in connection with a motor sports event, comprising:
soliciting from a plurality of participants at least one image associated with each of the participants;
collecting a fee from each participant submitting, or endorsing, an image in response to the solicitation;
assembling a mosaic from images provided by, or endorsed by, the participants;
arranging the mosaic upon a vehicle that will compete in the motor sports event;
attaching the mosaic to the vehicle; and
facilitating provision of affirmation to the participants of the vehicle's participation in the motor sports event.

14. The method of claim 13, wherein at least some of the images provided by, or endorsed by, the participants are representations of people.

15. The method of claim 14, wherein at least some of the representations of people are representations of the participants solicited.

16. The method of claim 13, further comprising: allowing the participants to select a location upon the vehicle in which the images submitted by the participants will be located.

17. The method of claim 13, further comprising: providing a plurality of vehicles upon which a mosaic will be attached, and allowing the participants to select a vehicle upon which the images submitted by the participants will be located.

18. The method of claim 13, wherein the matter includes a charitable organization or event.

19. The method of claim 13, wherein the mosaic covers substantially all of a plurality of exterior panels of the vehicle.

20. A method for promoting a matter in connection with a motor sports event, comprising:
soliciting from a plurality of participants at least one image representative of each of the participants;
allowing each participant submitting, or endorsing, an image to select a vehicle upon which the participant's mosaic will be attached;
collecting a fee from each participant submitting, or endorsing, an image in response to the solicitation;
assembling a mosaic from collective images provided by, or endorsed by, the participants;
arranging the mosaic upon a racecar that will compete in the motor sports event;
attaching the mosaic to the vehicle; and
facilitating provision of affirmation to the participants of the racecar's participation in the motor sports event.

21. The method of claim 20, further comprising: allowing each participant submitting, or endorsing, an image to select a location upon the vehicle in which the image submitted by the participant will be located.

22. The method of claim 20, wherein the matter includes a charitable organization or event.

23. The method of claim 20, wherein the mosaic covers substantially all of a plurality of exterior panels of the racecar.

24. The method of claim 20, wherein motor sports event is a sanctioned event.
